(19) United States
(12) Patent Application Publication
(10) Pub. No.: US 2010/0248036 A1
(43) Pub. Date: Sep. 30, 2010

(54) Lithium Secondary Battery

(75) Inventors: Takefumi Okumurai, Hitachinaka (JP); Shigetaka Tsubouchi, Tokai (JP); Ryo Inoue, Hitachinaka (JP); Kunio Fukuchi, Hitachiota (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Vehicle Energy, Ltd., Hitachinaka-shi (JP)

(21) Appl. No.: 12/695,632

(22) Filed: Jan. 28, 2010

(30) Foreign Application Priority Data
Mar. 30, 2009 (JP) 2009-080845

(51) Int. Cl. H01M 6/16

(52) U.S. Cl. 429/330; 429/326; 429/332

(57) ABSTRACT

A lithium secondary battery is intended to suppress deterioration upon storage at high temperature of 50° C. or higher without deteriorating the output characteristics at a room temperature.

The battery includes a positive electrode capable of occluding and releasing lithium ions, a negative electrode capable of occluding and releasing lithium ions, a separator disposed between the positive electrode and the negative electrode and an electrolyte, in which the electrolyte contains a compound represented by formula (1)

(R′O)ₙSiR₄₋ₙ (Formula 1)

where R′ represents an alkyl group, R is selected from hydrogen, an alkyl group, an alicyclic group, and an aryl group, each of R′ and R may be identical or different from each other, the alkyl group has a straight or branched chain having fewer than 10 carbon atoms, and n is an integer of 1 to 3, and a compound having a polymerizable group in the molecule.

### BACKGROUND OF THE INVENTION

1. Field of the Invention

The present invention relates to a lithium secondary battery, and more specifically, the invention relates to a lithium secondary battery in which increase of resistance during storage at high temperature is suppressed.

2. Description of the Related Art

With a view point of environmental protection and energy saving, hybrid cars that use in combination an engine and a motor together as a power source have been developed and put to actual products. Further, development of fuel cell type hybrid cars that use fuel cells instead of engines has been made vigorously for future use.

Secondary batteries capable of charging/discharging electric energy repetitively are technically essential as energy sources for hybrid cars.

Among them, a lithium secondary battery is a battery having a feature of a high energy-density, where operation voltage is high and high power is obtained easily. Such a lithium secondary battery is important more and more as the power source of the hybrid cars in the future.

For the lithium secondary battery which is used as the power source for the hybrid cars, one of its technical subjects is to suppress the increase of resistance during high temperature storage at 50° C. or higher.

To suppress the increase of resistance during storage at high temperature, a countermeasure of adding a compound such as vinylene carbonate to an electrolyte has been proposed.

A battery in which deterioration during storage at 60° C. can be suppressed by adding 2 wt % vinylene carbonate to an electrolyte comprising, for example, LiPF₆, ethylene carbonate, and dimethyl carbonate has been proposed in Journal of The Electrochemical Society, 151 (10) A1659-A1669 (2004).

### SUMMARY OF THE INVENTION

However, the technique utilizing vinylene carbonate proposed so far can suppress deterioration during storage at high temperature by increasing the addition amount, this involves a problem that the power lowers at a room temperature. That is, an object of the present invention is to provide a lithium secondary battery that is intended to suppress deterioration during storage at high temperature of 50° C. or higher without deteriorating the output characteristics at a room temperature.

The present invention provides a lithium secondary battery having a positive electrode capable of occluding and releasing lithium ions, a negative electrode capable of occluding and releasing lithium ions, a separator disposed between the positive electrode and the negative electrode, and an electrolyte, in which

the electrolyte contains a compound represented by formula (1):

(R′O)ₙSiR₄₋ₙ (Formula 1)

where R′ represents an alkyl group, R is selected from hydrogen, an alkyl group, an alicyclic group, and an aryl group, each of R′ and R may be identical or different from each other, the alkyl group has straight or branched chain having fewer than 10 carbon atoms, and n is an integer of 1 to 3, and a compound having a polymerizable group or a halogen in the molecule.

The positive electrode has a positive electrode mix and a positive electrode current collector. A positive electrode mix layer means a mix layer formed by coating a positive electrode mix containing a positive electrode active material, an electronically conductive material, and a binder on the positive electrode current collector.

Further, the negative electrode has a negative electrode mix and a negative electrode current collector. A negative electrode mix layer means a mix layer formed by coating a negative electrode mix containing a negative electrode active material, a conductive material, and a binder on the negative electrode current collector.

The present invention can provide a lithium secondary battery that suppresses deterioration during storage at high temperature without deteriorating the output characteristics of the lithium secondary battery at a room temperature.

### BRIEF DESCRIPTION OF THE DRAWING

Other objects and advantages of the invention will become apparent from the following description of embodiments with reference to the accompanying drawings in which:

FIG. 1 is a cross sectional view for one-half part of a wound battery according to a preferred embodiment of the invention.

### DESCRIPTION OF THE PREFERRED EMBODIMENTS

The present invention provides a lithium secondary battery having a positive electrode capable of occluding and releasing lithium ions, a negative electrode capable of occluding and releasing lithium ions, a separator disposed between the positive electrode and the negative electrode, and an electrolyte, in which

the electrolyte contains a compound represented by formula (1):

(R′O)ₙSiR₄₋ₙ (Formula 1)

where R′ represents an alkyl group, R is selected from hydrogen, an alkyl group, an alicyclic group, and an aryl group, each of R′ and R may be identical or different from each other, the alkyl group has straight or branched chain having fewer than 10 carbon atoms, and n is an integer of 1 to 3, and a compound having a polymerizable group or a halogen in the molecule.

The compound having the polymerizable group in the molecule is a compound represented by formula (2):

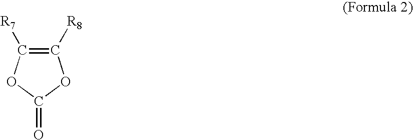

in which R₇ and R₈ each represent any one of hydrogen, fluorine, chlorine, an alkyl group having 1 to 3 carbon atoms and a fluorinated alkyl group having 1 to 3 carbon atoms, or

a compound represented by formula (3):

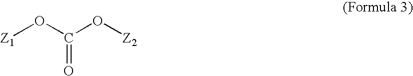

in which Z₁ and Z₂ each represent any one of a vinyl group, an acryl group, and methacryl group.

Further, it is preferable that the compound having the halogen in the molecule be fluoroethylene carbonate and the positive electrode contains a lithium composite oxide represented by the compositional formula: Li_{α}MnₓM1_{y}M2_{z}O₂ (in which M1 is at least one element selected from Co and Ni, and M2 is at least one element selected from Co, Ni, Al, B, Fe, Mg, and Cr, x+y+z=1, 0<α<1.2, 0.2≦x≦0.6, 0.2≦y≦0.4, and 0.05≦z≦0.4). Further, the negative electrode preferably has at least one element of carbonaceous materials, oxides containing group IV elements and nitrides containing group IV elements.

Further, it is preferable that the electrolyte contain, as a solvent, a cyclic carbonate represented by formula (4):

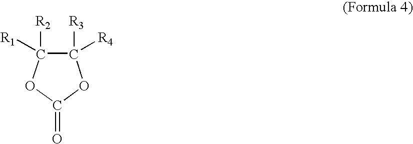

in which, R₁, R₂, R₃, and R₄ each represent any one of hydrogen, fluorine, chlorine, an alkyl group having 1 to 3 carbon atoms and a fluorinated alkyl group having 1 to 3 carbon atoms, and a linear carbonate represented by formula (5)

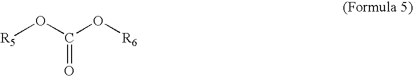

in which R₅ and R₆ each represent any one of hydrogen, fluorine, chlorine, an alkyl group having 1 to 3 carbon atoms and a fluorinated alkyl group having 1 to 3 carbon atoms.

Further, a lithium secondary battery according to the invention is a lithium secondary battery having a positive electrode capable of occluding and releasing lithium ions, a negative electrode capable of occluding and releasing lithium ions, a separator disposed between the positive electrode and the negative electrode, and an electrolyte, in which the electrolyte contains a cyclic carbonate represented by formula (6):

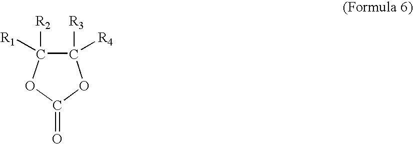

in which, R₁, R₂, R₃, and R₄ each represent any one of hydrogen, fluorine, chlorine, an alkyl group having 1 to 3 carbon atoms and a fluorinated alkyl group having 1 to 3 carbon atoms,

a linear carbonate represented by formula (7):

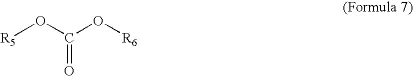

in which R₅ and R₆ each represent any one of hydrogen, fluorine, chlorine, an alkyl group having 1 to 3 carbon atoms and a fluorinated alkyl group having 1 to 3 carbon atoms,

a compound represented by formula (8):

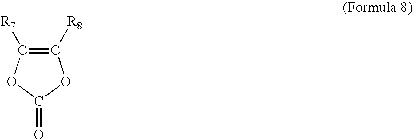

in which R₇ and R₈ each represent any one of hydrogen, fluorine, chlorine, an alkyl group having 1 to 3 carbon atoms, and a fluorinated alkyl group having 1 to 3 carbon atoms, and

a compound represented by formula (9):

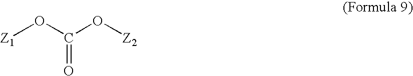

in which Z₁ and Z₂ each represent any one of a vinyl group, an acryl group, and methacryl group, and containing

alkoxysilane and a compound containing a halogen.

The alkoxysilane is preferably at least one of trimethylethoxysilane, dimethyldiethoxysilane, methyltrimethoxysilane, or dimethyldimethoxysilane.

Preferably, the compositional ratio of the compound represented by formula (6) is 18.0 vol % or more and 30.0 vol % or less, the compound represented by formula (7) is 74.0 vol % or more and 81.8 vol % or less, the compound represented by formula (8) is 0.1 vol % or more and 1.0 vol % or less, and the compound represented by formula (9) is 0.1 vol % or more and 1.0 vol % or less, the compositional ratio of the alkoxysilane and the compound having the halogen is 0.1 vol % or more and 1.0 vol % or less, and the total volume for the compound represented by formula (6), the compound represented by formula (7), the compound represented by formula (8), the compound represented by formula (9), the alkoxysilane, and the compound having the halogen is 100 vol %.

Preferably, the compound represented by formula (6) is ethylene carbonate, the compound represented by formula (7) is at least one of ethyl methyl carbonate and dimethyl carbonate, the compound represented by formula (8) is vinylene carbonate, and the compound represented by formula (9) is dimethacryl carbonate. In the case where the compositional ratio of fluoroethylene carbonate is 1.0 vol % or more, this is not preferred since the internal resistance of the battery increases to result in lowering of the battery power.

As the compound represented by formula 1, trimethylethoxysilane, dimethyldiethoxysilane, methyltrimethoxysilane, and dimethyldimethoxysilane, etc. can be used. Particularly, dimethyldimethoxysilane is preferred since it has high deterioration suppressing effect by a small amount.

As the compound represented by formula (2) or formula (8), vinylene carbonate (VC), methyl vinylene carbonate (MVC), dimethyl vinylene carbonate (DMVC), ethyl vinylene carbonate (EVC), diethyl vinylene carbonate (DEVC), etc. can be used. It is considered that VC has a small molecular weight and forms a dense electrode coating film. It is considered that MVC, DMVC, EVC, DEVC, etc, in which an alkyl group is substituted on VC form an electrode coating film of low density depending on the length of the alkyl chain, and it is considered that they function effectively for the improvement of the low temperature characteristics.

The compound represented by formula (3) or formula (9) includes, for example, dimethallyl carbonate (DMAC).

As the compound represented by formula (4) or formula (6), ethylene carbonate (EC), trifluoropropylene carbonate (TFPC), chloroethylene carbonate (ClEC), fluoroethylene carbonate (FEC), trifluoroethylene carbonate (TFEC), difluoroethylene carbonate (DFEC), and vinyl ethylene carbonate (VEC), etc. can be used. Particularly, EC is used preferably with a view point of forming a coating film on the negative electrode. Further, addition of a small amount (2 vol % or less) of ClEC, FEC, TFEC, or VEC also contributes to the formation of the electrode coating film to provide good cycle characteristics. Further, TFPC or DFEC may also be used by a small amount (2 vol % or less) of addition with the view point of forming a coating film on the positive electrode.

As the compound represented by formula (5) or (7), dimethyl carbonate (DMC), ethyl methyl carbonate (EMC), diethyl carbonate (DEC), methylpropyl carbonate (MPC), ethyl propyl carbonate (EPC), trifluoromethylethyl carbonate (TFMEC), and 1,1,1-trifluoroethylmethyl carbonate (TFEMC) can be used. DMC is a highly compatible solvent and is suitable to be used in admixture with EC, etc. DEC has a melting point lower than that of DMC and is suitable for a low temperature (−30° C.) characteristics. Since EMC has an asymmetric molecular structure and low melting point, it is suitable in view of the low temperature characteristics. Since EPC and TFMEC have a propylene side chain and an asymmetric molecular structure, they are suitable as the solvent for controlling the low temperature characteristics. Since TFEMC is fluorinated for a portion of the molecule to increase a dipole moment, it is suitable for maintaining dissociation property of a lithium salt at low temperature and suitable for the low temperature characteristics.

Then, the lithium salt used as the electrolyte is not particularly restricted, and inorganic lithium salts, such as LIPF₆, LIBF₄, LiClO₄, LiI, LiCl, and LiBr, and organic lithium salts such as LiB[OCOCF₃]₄, LiB[OCOCF₂CF₃]₄, LiPF₄(CF₃)₂, LiN(SO₂CF₃)₂, LiN(SO₂CF₂CF₃)₂, etc. can be used. Particularly, LiPF₆ used frequently in domestic batteries is a suitable material with a view point of stability for the quality. LiB[OCOCF₃]₄ is an effective material since this is excellent in the dissociation property and solubility and shows a high conductivity at low concentration.

The positive electrode is formed by coating a positive electrode mix layer comprising a positive electrode active material, an electron conducting material, and a binder on an aluminum foil as a current collector. A conductive agent may be further added to the positive electrode mix layer for decreasing the electronic resistance. The positive electrode active material is preferably a lithium composite oxide represented by the compositional formula: Li_{αMn}ₓM1_{y}M2_{z}O₂ (in which M1 is at least one element selected from Co and Ni, M2 is at least one element selected from Co, Ni, Al, B, Fe, Mg, and Cr, x+y+z=1, 0<α<1.2, 0.2≦x≦0.6, 0.2≦y≦0.4, and 0.05≦z≦0.4). Among them, it is more preferred that M1 is Ni or Co and M2 is Co or Ni. LiMn_{1/3}Ni_{1/3}CO_{1/3}O₂ is further preferred. In the composition, capacity can be increased when Ni is increased, power at a low temperature can be improved when Co is increased, and material cost can be suppressed when Mn is increased. Further, the additive element is effective for stabilizing the cycle characteristics. In addition, an orthorhombic phosphate compound represented by the general formula: LiMₓPO₄ (M: Fe or Mn, and 0.01≦X≦0.4) or LiMn₁₋ₓMₓPO₄ (M: bivalent cation other than Mn, and 0.01≦X≦0.4) having symmetricity of a space group Pmnb may also be used. Particularly, LiMn_{1/3}Ni_{1/3}CO_{1/3}O₂ has a high low temperature characteristics and cycle stability and is suitable as a lithium battery material for hybrid cars (HEV). Any binder may be used so long as it can closely adhere to the material constituting the positive electrode and a current collector for the positive electrode and includes, for example, a homopolymer or a copolymer of vinylidene fluoride, tetrafluoroethylene, acrylonitrile, and ethylene oxide, and styrene-butadiene rubber. The conductive agent is, for example, a carbon material such as carbon black, graphite, carbon fiber, and metal carbide, which may be used each alone or in admixture.

The negative electrode is formed by coating a negative electrode mix layer comprising a negative electrode active material and a binder on a copper foil as a current collector. To decrease the electronic resistance, a conductive agent may also be added further to the negative active electrode mix layer. Materials usable as the negative electrode active material include: carbonaceous materials such as natural graphite; composite carbonaceous materials in which a coating film which is formed by a dry CVD (Chemical Vapor Deposition) method or a wet spray method is formed on natural graphite; artificial graphite prepared by baking a resin material such as epoxy or phenol or pitch type materials obtained from petroleum or coal as the starting material; carbonaceous materials such as amorphous carbon materials; lithium metal capable of occluding and releasing lithium by forming a compound with lithium; and oxides or nitrides of group IV elements such as silicon, germanium, or tin capable of occluding and releasing lithium by forming compounds with lithium by intercalation into crystal gaps. They are sometimes referred to generally as a negative electrode active material. Particularly, the carbonaceous materials are excellent materials in view of high conductivity, low temperature characteristics and cycle stability. Among the carbonaceous materials, those having wide carbon interplanar spacing (d₀₀₂) are excellent in rapid charge/discharge and low temperature characteristics and are suitable. However, since the materials having wide d₀₀₂ sometimes cause lowering of capacity at the initial stage of charging and show low charge/discharge efficiency, d₀₀₂ is preferably 0.39 nm or less, and such carbonaceous materials are sometimes referred to as pseudo anisotropic carbon. Further, for constituting the electrode, carbonaceous materials of high conductivity such as graphite, amorphous or activated carbon may also be mixed. Alternatively, as the graphite materials, those materials having the features to be shown in (1) to (3) below may also be used.

(1) Materials having R value (I_{D}/I_{G}) of 0.2 or more and 0.4 or less as the intensity ratio between the peak intensity (I_{D}) within a range from 1300 to 1400 cm⁻¹ measured by Raman spectroscopy and a peak intensity (I_{G}) within a range from 1580 to 1620 cm⁻¹ measured by Raman spectroscopy.

(2) Materials having a half-value width A value of 40 cm⁻¹ or more and 100 cm⁻¹ or less for a peak within a range from 1300 to 1400 cm⁻¹ measured by Raman spectroscopy.

(3) Materials having an intensity ratio X-value (I₍₁₁₀₎/I₍₀₀₄₎) of 0.1 or more and 0.45 or less between the peak intensity (I₍₁₁₀₎) at the (110) face and the peak intensity (I₍₀₀₄₎) at the (004) face in X-ray diffractometry.

As the binder, any material capable of closely adhering to the material constituting the negative electrode and the current collector for the negative electrode may be used and includes, for example, homopolymers or copolymers of vinylidene fluoride, tetrafluoride ethylene, acrylonitrile and ethylene oxide, and styrene-butadiene rubber. The conductive agent comprises, for example, carbon materials such as carbon black, graphite, carbon fiber, and metal carbide, and they may be each alone or in admixture.

As described above, since the lithium secondary battery as an embodiment of the invention can provide a lithium secondary battery capable of suppressing deterioration during storage at high temperature of 50° C. or higher without deteriorating the output characteristics at a room temperature when compared with existent secondary batteries, it can be used generally as a power source for hybrid cars, a power source or a back-up power source for electromotive control systems in automobiles that are possibly exposed to a high temperature of 50° C. or higher and it is suitable also as a power source for industrial equipments such as electromotive tools and forklifts.

A best mode for practicing the invention is to be described with reference to specific examples.

### Example 1

### Manufacture of Wound Battery

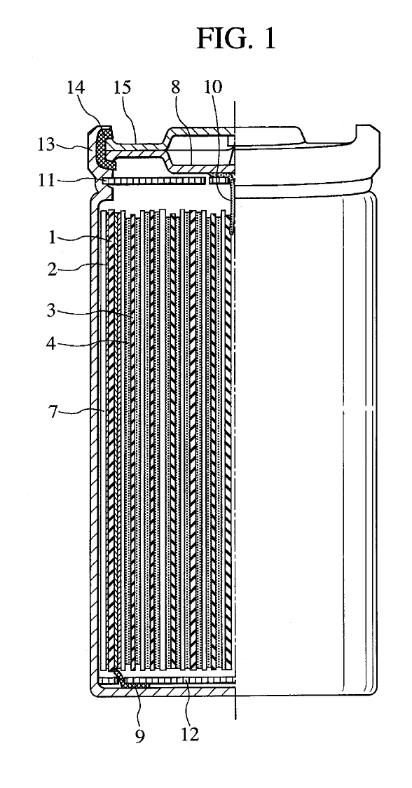

A wound battery of this example was manufactured by the method shown below. FIG. 1 shows a cross sectional view for one-half part of a wound battery.

A positive electrode material paste was at first prepared by using LiMn_{1/3}Ni_{1/3}CO_{1/3}O₂ as a positive electrode active material, carbon black (CB1) and graphite (GF2) as an electronic conductive material, and polyvinylidene fluoride (PVDF) as a binder, and using NMP (N-methylpyrrolidone) as a solvent such that the solid content weight in a dried state was at a ratio of: LiMn_{1/3}Ni_{1/3}CO_{1/3}O₂:CB1:GF2:PVDF=86:9:2:3.

The positive electrode material paste was coated over an aluminum foil as a positive electrode current collector 1, dried at 80° C., pressed by a pressing roller, and dried at 120° C. to form a positive electrode mix layer 2 to the positive electrode current collector 1.

Then, a negative electrode material paste was prepared by using a pseudo anisotropic carbon which is amorphous carbon as a negative electrode active material, carbon black (CB2) as a conductive material, and PVDF as a binder, and using NMP as a solvent such that the solid content weight in a dried state was at a ratio of: pseudo anisotropic carbon:CB2:PVDF=88:5:7.

The negative electrode material paste was coated over a copper foil as a negative electrode current collector 3, dried at 80° C., pressed by a pressing roller, and dried at 120° C. to form a negative electrode mix layer 4 to the negative electrode current collector 3.

An electrolyte was prepared by using solvents mixed at a volumic compositional ratio of DDS (dimethoxydimethyl silane):VC (vinylene carbonate):EC:DMC:EMC=0.5:0.5:20:39.5:39.5 as the electrolyte and dissolving 1 M of LiPF₆ as a lithium salt.

A separator 7 is sandwiched between the thus prepared electrodes to form a wound group and inserted in a negative electrode battery can 13. Then, for current collection to the negative electrode, one end of a negative electrode lead 9 made of nickel was welded to the negative electrode current collector 3 and the other end thereof was welded to the negative electrode battery can 13. Further, for current collection to the positive electrode, one end of a positive electrode lead 10 made of aluminum was welded to the positive electrode current collector 1, and the other end thereof was welded to a current shut-off valve 8 and, further, electrically connected by way of the current shut-off valve 8 with a positive electrode battery lid 15. A wound battery was manufactured by further injecting a liquid electrolyte and caulking the same.

In FIG. 1, a positive electrode insulator 11, a negative electrode insulator 12, a gasket 14, and a positive electrode battery lid 15 are shown.

### (Evaluation for Battery)

The capacity retention ratio of the wound battery shown in FIG. 1 during storage at 50° C. was evaluated. Evaluation method is to be described below.

### [Method for Evaluating the Capacity Retention Ratio]

At 25° C., a battery was charged to 4.1 V at a constant current of 0.7 A, charged till the current value reached 20 mA at a constant voltage of 4.1 V, after operation recess for 30 minutes, discharge to 2.7 V at 0.7 A, and the discharge capacity was evaluated. The operations were repeated three times, and the discharge capacity at the third cycle was defined as an initial discharge capacity.

Then, at 25° C., the battery was charged to 4.1 V at a constant current of 0.7 A, and charged till the current value reached 20 mA at a constant voltage of 4.1 V. The charged battery was stored in a thermostatic bath at 50° C. and the discharge capacity was evaluated at 60th day. At 25° C., the battery was charged to 4.1 V at a constant current of 0.7 A, charged till the current value reached 20 mA at a constant voltage of 4.1 V, after operation recess for 30 minutes, discharged to 2.7 V at 0.7 A, and the discharge capacity was evaluated.

The capacity retention ratio was determined by the following formula.

(Capacity retention ratio)=(discharge capacity at 60th day)/(initial discharge capacity)×100

Table 1 shows the result of the measurement.

### Example 2

A wound battery was manufactured under the same conditions as in Example 1 except for using an electrolyte formed by mixing solvents at a volumic compositional ratio of DDS:DMAC (dimethacryl carbonate):EC:DMC:EMC=0.5:0.5:20:39.5:39.5, and dissolving 1 M of LiPF₆ as a lithium salt, and the capacity retention ratio was evaluated by the same method as in Example 1. Table 1 shows the result thereof.

### Example 3

A wound battery was manufactured under the same conditions as in Example 1 except for using an electrolyte formed by mixing solvents at a volumic compositional ratio of DDS:FEC (fluoroethylene carbonate):EC:DMC:EMC=0.5:0.5:20:39.5:39.5, and dissolving 1 M of LiPF₆ as a lithium salt and the capacity retention ratio was evaluated by the same method as in Example 1. Table 1 shows the result thereof.

### Example 4

A wound battery was manufactured under the same conditions as in Example 1 except for using an electrolyte formed by mixing solvents at a volumic compositional ratio of DDS:FEC (fluoroethylene carbonate):EC:DMC:EMC=0.5:0.5:20:39.5:39.5, and dissolving 1.2 M of LiPF₆ as a lithium salt and the capacity retention ratio was evaluated by the same method as in Example 1. Table 1 shows the result thereof.

### Comparative Example 1

A wound battery was manufactured under the same conditions as in Example 1 except for using an electrolyte formed by mixing solvents at a volumic compositional ratio of DDS:EC:DMC:EMC=1:20:39.5:39.5, and dissolving 1 M of LiPF₆ as a lithium salt and the capacity retention ratio was evaluated by the same method as in Example 1. Table 1 shows the result thereof.

### Comparative Example 2

A wound battery was manufactured under the same conditions as in Example 1 except for using an electrolyte formed by mixing solvents at a volumic compositional ratio of VC:EC:DMC:EMC=1:20:39.5:39.5, and dissolving 1 M of LiPF₆ as a lithium salt and the capacity retention ratio was evaluated by the same method as in Example 1. Table 1 shows the result thereof.

### Comparative Example 3

A wound battery was manufactured under the same conditions as in Example 1 except for using an electrolyte formed by mixing solvents at a volumic compositional ratio of DMAC:EC:DMC:EMC=1:20:39.5:39.5, and dissolving 1 M of LiPF₆ as a lithium salt and the capacity retention ratio was evaluated by the same method as in Example 1. Table 1 shows the result thereof.

### Comparative Example 4

A wound battery was manufactured under the same conditions as in Example 1 except for using an electrolyte formed by mixing solvents at a volumic compositional ratio of FEC:EC:DMC:EMC=1:20:39.5:39.5, and dissolving 1 M of LiPF₆ as a lithium salt and the capacity retention ratio was evaluated by the same method as in Example 1. Table 1 shows the result thereof.

TABLE 1

| | | | | | | | | | Capacity |
|---|---|---|---|---|---|---|---|---|---|
| | | | | | | | | | retention |
| | | | | | | | | | ratio |
| | | | | | | | | | after a |
| | | | | | | | | | lapse |
| | Electrolyte composition | | | | | | | | of 60 |
| | LiPF₆ | DDS | VC | DMAC | FEC | EC | DMC | EMC | days |
| | (M) | (vol %) | (vol %) | (vol %) | (vol %) | (vol %) | (vol %) | (vol %) | (%) |
| Example 1 | 1 | 0.5 | 0.5 | — | — | 20 | 39.5 | 39.5 | 90 |
| Example 2 | 1 | 0.5 | — | 0.5 | — | 20 | 39.5 | 39.5 | 93 |
| Example 3 | 1 | 0.5 | — | — | 0.5 | 20 | 39.5 | 39.5 | 92 |
| Example 4 | 1.2 | 0.5 | — | — | 0.5 | 20 | 39.5 | 39.5 | 94 |
| Comp. | 1 | 1 | — | — | — | 20 | 39.5 | 39.5 | 86 |
| Example 1 | | | | | | | | | |
| Comp. | 1 | — | 1 | — | — | 20 | 39.5 | 39.5 | 80 |
| Example 2 | | | | | | | | | |
| Comp. | 1 | — | — | 1 | — | 20 | 39.5 | 39.5 | 84 |
| Example 3 | | | | | | | | | |
| Comp. | 1 | — | — | — | 1 | 20 | 39.5 | 39.5 | 76 |
| Example 4 | | | | | | | | | |

It can be seen that the batteries described in Examples 1 to 3 with addition of DDS and VC, DMAC or FEC to the electrolyte showed higher capacity retention ratio and less deterioration of performance during storage at high temperature compared with the batteries of Comparative Examples 1 to 4 with no such addition. As described above, Examples 1 to 4 can provide batteries that suppress the deterioration during storage at high temperature of 50° C. or higher.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A lithium ion secondary battery comprising:
a positive electrode, a negative electrode, a separator disposed between the positive electrode and the negative electrode, and an electrolyte,
wherein the electrolyte contains a compound represented by formula 1:
(R′O)ₙSiR₄₋ₙ (Formula 1),
wherein R′ represents an alkyl group having a straight or branched chain having fewer than 10 carbon atoms, and n is an integer of 1 to 3,
R is selected from one of hydrogen, an alkyl group having a straight or branched chain having fewer than 10 carbon atoms, and
n is an integer of 1 to 3, an alicyclic group, and an aryl group, and
at least one of a compound having a polymerizable group and a halogenic compound.

2. The lithium secondary battery according to claim 1,
wherein the compound represented by formula 1 is alkoxysilane.

3. The lithium secondary battery according to claim 1,
wherein the compound having the polymerizable group is represented by formula (2) or formula (3), 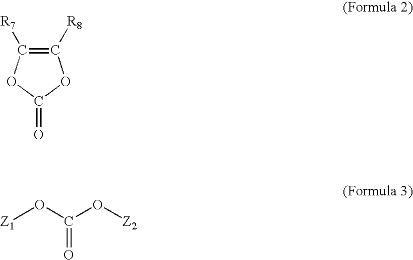
wherein Z₁ and Z₂ each represent one of a vinyl group, an acryl group, and a methacryl group,
wherein R₇ and R₈ each represent one of hydrogen, fluorine, chlorine, an alkyl group having 1 to 3 carbon atoms and a fluorinated alkyl group having 1 to 3 carbon atoms.

4. The lithium secondary battery according to claim 1, wherein the halogen compound is fluoroethylene carbonate.

5. The lithium secondary battery according to claim 1,
wherein the positive electrode contains a lithium composite oxide represented by Li_{α}MnₓM1_{y}M2_{z}O₂, wherein M1 is at least one element selected from Co and Ni,
M2 is at least one element selected from Co, Ni, Al, B, Fe, Mg, and Cr,
x+y+z=1,
0<α<1.2, 0.2≦x≦0.6, 0.2≦y≦0.4, and 0.05≦z≦0.4.

6. The lithium secondary battery according to claim 1, wherein the negative electrode has at least one element of carbonaceous materials, oxides containing group IV elements, and nitrides containing group IV elements.

7. The lithium secondary battery according to claim 1, wherein the electrolyte further contains a cyclic carbonate represented by formula (4), 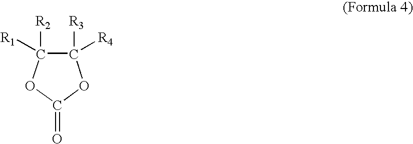
and a linear carbonate represented by formula (5), 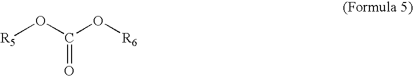
wherein, R₁, R₂, R₃, R₄, R₅ and R₆ each represent one of hydrogen, fluorine, chlorine, an alkyl group having 1 to 3 carbon atoms and a fluorinated alkyl group having 1 to 3 carbon atoms.

8. The lithium secondary battery according to claim 2,
wherein the alkoxysilane is at least one of trimethylethoxysilane, dimethyldiethoxysilane, methyltrimethoxysilane, and dimethyldimethoxysilane.

9. A lithium secondary battery comprising:
a positive electrode, a negative electrode, a separator disposed between the positive electrode and the negative electrode, and an electrolyte,
wherein the electrolyte contains a cyclic carbonate represented by formula (6), a linear carbonate represented by formula (7), a compound represented by formula (8), a compound represented by formula (9), alkoxysilane, and a halogen compound,
wherein formula (6) is below; 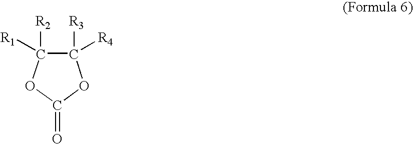
wherein formula (7) is below; 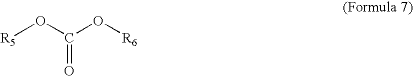
wherein formula (8) is below; 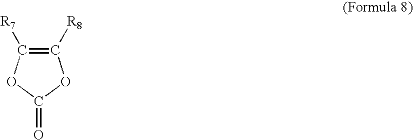
wherein formula (9) is below; 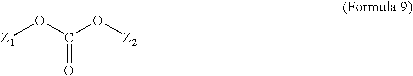
wherein R₁, R₂, R₃, R₄, R₅, R₆, R₇ and R₈ each represent one of hydrogen, fluorine, chlorine, an alkyl group having 1 to 3 carbon atoms and a fluorinated alkyl group having 1 to 3 carbon atoms, and
wherein Z₁ and Z₂ each represent one of a vinyl group, an acryl group, and a methacryl group.

10. The lithium secondary battery according to claim 9, wherein the alkoxysilane is at least one of trimethylethoxysilane, dimethyldiethoxysilane, methyltrimethoxysilane, and dimethyldimethoxysilane.

11. The lithium secondary battery according to claim 9,
wherein the compositional ratio of the compound represented by formula (6) is 18.0 vol % or more and 30.0 vol % or less,
the compositional ratio of the compound represented by formula (7) is 74.0 vol % or more and 81.8 vol % or less,
the compositional ratio of the compound represented by formula (8) is 0.1 vol % or more and 1.0 vol % or less,
the compositional ratio of the compound represented by formula (9) is 0.1 vol % or more and 1.0 vol % or less,
the compositional ratio of the alkoxysilane is 0.1 vol % or more and 1.0 vol % or less,
the compositional ratio of the compound containing the halogen is 0.1 vol % or more and 1.0 vol % or less,
under assumption that the total volume for the compound represented by formula (6), the compound represented by formula (7), the compound represented by formula (8), the compound represented by formula (9), the alkoxysilane, and the compound having the halogen is 100 vol %.

12. The lithium secondary battery according to claim 9,
wherein the electrolyte essentially consists of the compound represented by formula (6), the compound represented by formula (7), the compound represented by formula (8), the compound represented by formula (9), the alkoxysilane, and the compound having the halogen.

13. The lithium secondary battery according to claim 9,
wherein the compound represented by formula (6) is ethylene carbonate, the compound represented by formula (7) is at least one of ethyl methyl carbonate and dimethyl carbonate, the compound represented by formula (8) is vinylene carbonate, and the compound represented by formula (9) is dimethacryl carbonate.

14. The lithium secondary battery according to claim 9,
wherein the compound represented by formula (6), the compound represented by formula (7), the compound represented by formula (8), the compound represented by formula (9), the alkoxysilane, and the compound having the halogen have a total volume with the following compositional ratios:
the compositional ratio of the compound represented by formula (6) is 18.0 vol % or more and 30.0 vol % or less,
the compositional ratio of the compound represented by formula (7) is 74.0 vol % or more and 81.8 vol % or less,
the compositional ratio of the compound represented by formula (8) is 0.1 vol % or more and 1.0 vol % or less,
the compositional ratio of the compound represented by formula (9) is 0.1 vol % or more and 1.0 vol % or less,
the compositional ratio of the alkoxysilane is 0.1 vol % or more and 1.0 vol % or less,
the compositional ratio of the compound containing the halogen is 0.1 vol % or more and 1.0 vol % or less.
